(19) United States
(12) Patent Application Publication
(10) Pub. No.: US 2005/0233706 A1
(43) Pub. Date: Oct. 20, 2005

(54) Switching circuit

(75) Inventor: Toru Takeda, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 10/855,433

(22) Filed: May 28, 2004

(30) Foreign Application Priority Data
Apr. 16, 2004 (JP) 2004-121904

(51) Int. Cl. H04B 1/44; H04Q 11/00; H04B 1/38

(52) U.S. Cl. 455/78; 455/73

(57) ABSTRACT

A switching circuit disclosed herein comprises: a transmission port; a first internal connection switching circuit which is connected between the transmission port and an antenna port and includes a depletion mode first transistor and a depletion mode second transistor, the first internal connection switching circuit constituting a parallel resonant circuit and a series resonant circuit; a reception port; a second internal connection switching circuit which is connected between the reception port and the antenna port and includes a depletion mode third transistor and a depletion mode fourth transistor, the second internal connection switching circuit constituting a parallel resonant circuit and a series resonant circuit; a standby port; a third internal connection switching circuit which is connected between the standby port and the antenna port and includes a depletion mode fifth transistor, the third internal connection switching circuit connecting the standby port to the antenna port and separating the standby port from the antenna port; and a control terminal.

### CROSS REFERENCE TO RELATED APPLICATION

This application claims benefit of priority under 35 U.S.C.§119 to Japanese Patent Application No. 2004-121904, filed on April 16, 2004, the entire contents of which are incorporated by reference herein.

### BACKGROUND OF THE INVENTION

1. Field of the Invention

The present invention relates to a switching circuit, and particularly relates to a switching circuit including a standby port.

2. Background Art

In recent years, an active radio tag system is being studied. A tag device used in such a system always needs to respond to a signal from an identification device, and hence the device not only needs to be always powered on but also needs to be operated for a long time by only a built-in battery. Therefore, a mechanism, in which a high-frequency signal is monitored by a monitoring circuit which operates with low power consumption in a standby mode, that is, a waiting state where no communication is performed and the entire system starts to operate when the signal is detected, is used. For this purpose, a transmission/reception switching circuit which has a standby port and whose power consumption in a standby mode is a few hundred nA or less is required. However, the control current in a today's general high-frequency switching circuit in which a GaAsFET is used is approximately a few μA. If the size of the FET is reduced, the control current can be reduced, but this causes a problem that the property required as the high-frequency switching circuit becomes unobtainable.

FIG. 1 shows an example of the related high-frequency switching circuit. The general high-frequency switching circuit uses a depletion mode MESFET (Metal Semiconductor Field Effect Transistor), the general high-frequency switching circuit includes a transmission port, a reception port and a standby port. Transistors Q1, Q2, and Q3 are respectively inserted between these ports and an antenna port.

Reactance elements L1, L2, and L3 are connected in parallel with the transistors Q1, Q2, and Q3, respectively. Gates of the transistors Q1, Q2, and Q3 are connected to control terminals T1, T2, and T3 via resistances R1, R2, and R3, respectively.

FIG. 2 is a diagram showing a truth table for operating the high-frequency switching circuit in FIG. 1. As shown in FIG. 2, in order to turn off the transistors Q1, Q2, and Q3, the gate bias voltage needs to be a reverse bias. For this purpose, it is necessary to send a reverse current which is determined by a backward current at a Schottky junction to the gates of the transistors Q1, Q2, and Q3. For example, when the transistor Q3 is turned on to thereby connect the standby port to the antenna port, it is necessary to apply a reverse bias to send a reverse current in order to turn off the transistors Q1 and Q2. This reverse current is approximately a few μA in the case of the general high-frequency switching circuit. To reduce the backward current, the size of the FET has only to be reduced, but in this case, the property required as the high-frequency switching circuit becomes unobtainable.

On the other hand, in T. Tokumitsu, I. Toyoda and M. Aikawa “A Low-Voltage, High-Power T/R-Switch MMIC Using LC Resonators”IEEE Trans. on Microwave Theory and Tech., vol. 43, No, 5, May 1995, pp. 997-1003, an antenna transmission/reception switching circuit shown in FIG. 3 is disclosed. This switching circuit in FIG. 3 includes transistors Q11 to Q16, reactance elements L11 and L12, and capacitors C11 to C14.

FIG. 4 is a diagram showing a truth table for operating the switching circuit in FIG. 3. As shown in FIG. 3, in such a switching circuit, when 0 V is applied to a control terminal T11, an antenna port is connected to a transmission port. However, since a standby port is not provided, if nothing is done, this switching circuit cannot be used in a system which needs the standby port. Moreover, a negative control circuit is needed, which causes a problem that the system is complicated.

### SUMMARY OF THE INVENTION

In order to accomplish the aforementioned and other objects, according to one aspect of the present invention, a switching circuit, comprises:
a transmission port which is connectable to a transmission circuit;
a first internal connection switching circuit which is connected between the transmission port and an antenna port and which includes a depletion mode first transistor and a depletion mode second transistor, the first internal connection switching circuit constituting a parallel resonant circuit by turning on the first transistor and the second transistor, and constituting a series resonant circuit by turning off the first transistor and the second transistor;
a reception port which is connectable to a reception circuit;
a second internal connection switching circuit which is connected between the reception port and the antenna port and which includes a depletion mode third transistor and a depletion mode fourth transistor, the second internal connection switching circuit constituting a parallel resonant circuit by turning on the third transistor and the fourth transistor, and constituting a series resonant circuit by turning off the third transistor and the fourth transistor;
a standby port which is connectable to a standby circuit;
a third internal connection switching circuit which is connected between the standby port and the antenna port and which includes a depletion mode fifth transistor, the third internal connection switching circuit connecting the standby port to the antenna port by turning on the fifth transistor, and separating the standby port from the antenna port by turning off the fifth transistor; and
a control terminal which is connected to the antenna port and to which a first voltage is inputted when the standby port is connected to the antenna port such that gate bias voltages of the first to fifth transistors become 0 V and the first to fifth transistors are turned on.

### BRIEF DESCRIPTION OF THE DRAWINGS

FIG. 1 is a diagram showing an example of the configuration of a related switching circuit;

FIG. 2 is a diagram showing a truth table explaining the operation of the switching circuit in FIG. 1;

FIG. 3 is a diagram showing an example of the configuration of another related switching circuit;

FIG. 4 is a diagram showing a truth table explaining the operation of the switching circuit in FIG. 3;

FIG. 5 is a diagram showing an example of the configuration of a transmission/reception system according to a first embodiment;

FIG. 6 is a diagram showing a truth table explaining the operation of a switching circuit in the transmission/reception system in FIG. 5;

FIG. 7 is a diagram showing an example of the configuration of a transmission/reception system according to a second embodiment; and

FIG. 8 is a diagram showing an example of the configuration of a transmission/reception system according to a third embodiment.

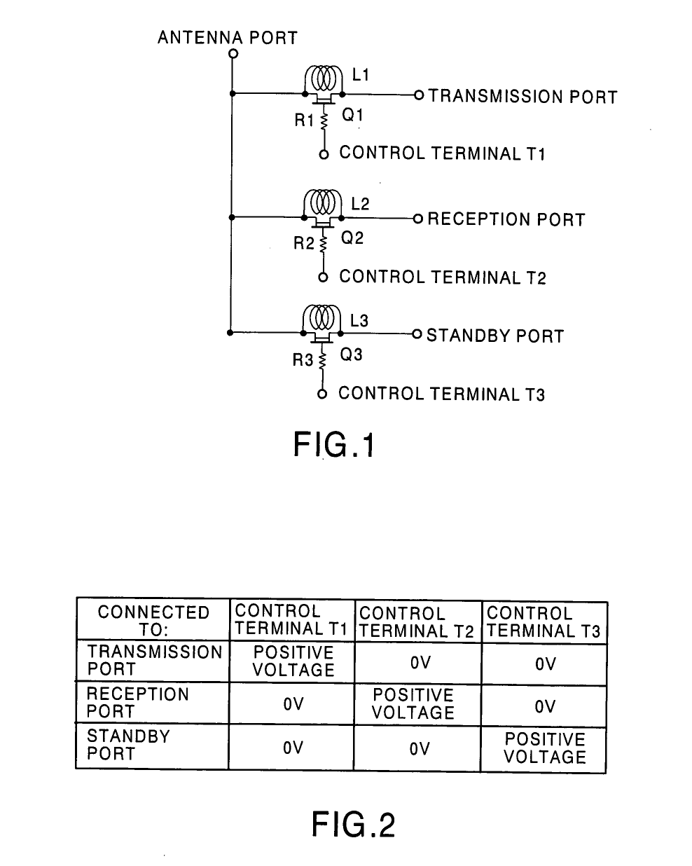

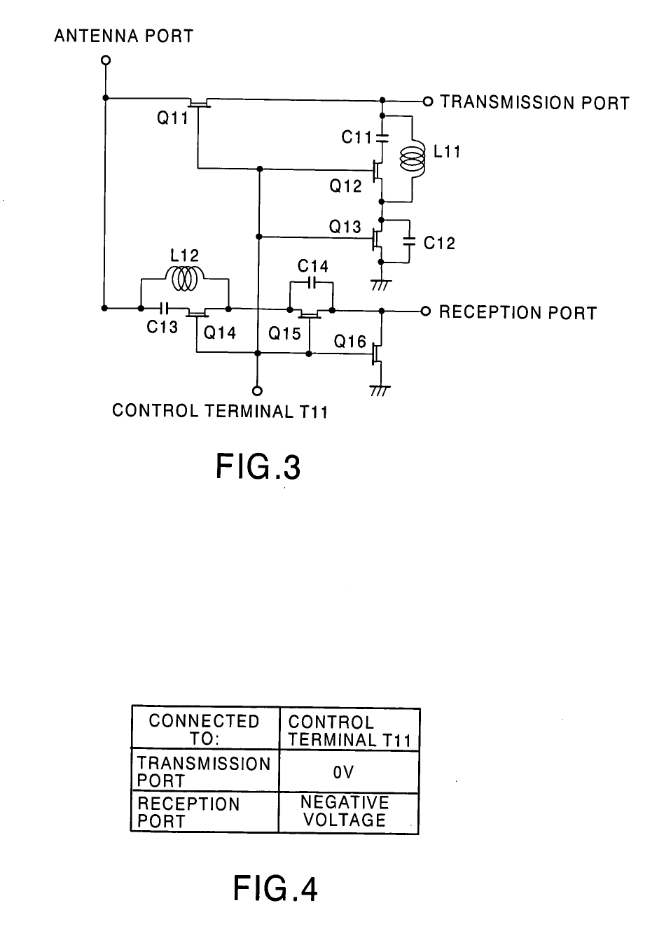

### DETAILED DESCRIPTION OF THE EMBODIMENTS

### First Embodiment

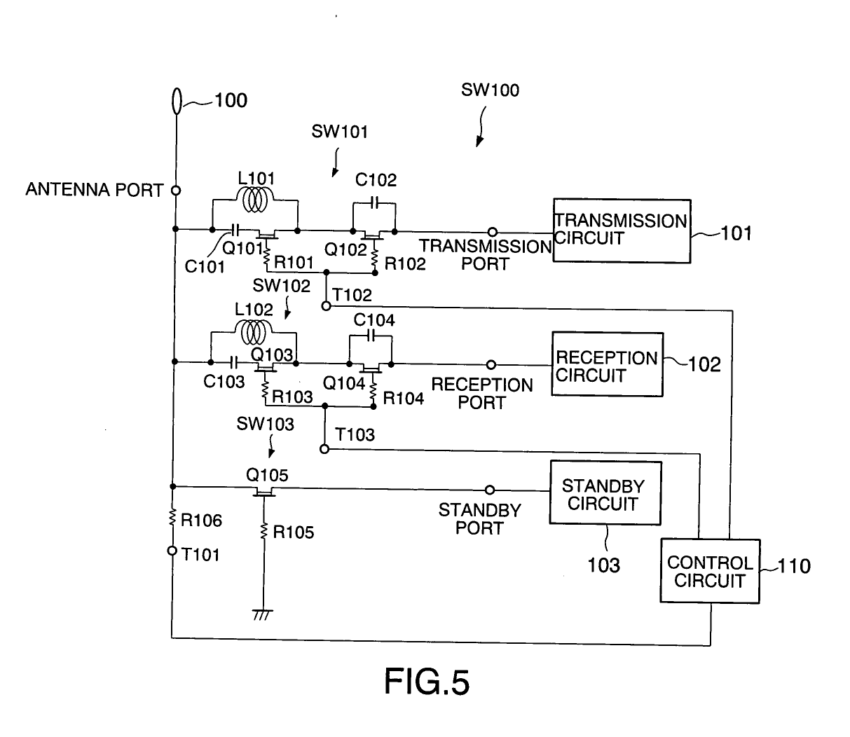

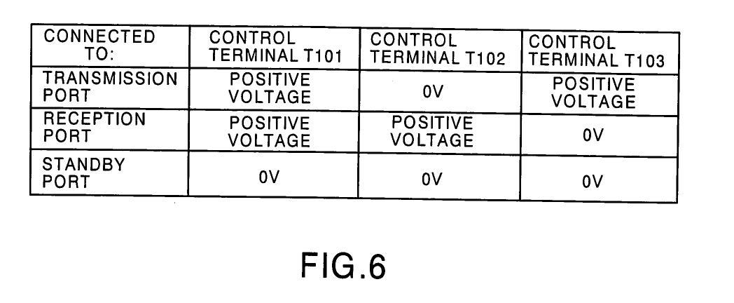

FIG. 5 is a diagram showing the internal configuration of a transmission/reception system according to this embodiment, and FIG. 6 is a diagram showing a truth table explaining the operation of the transmission/reception system in FIG. 5.

As shown in FIG. 5, the transmission/reception system according to this embodiment includes an antenna 100, a switching circuit SW100, a transmission circuit 101, a reception circuit 102, a standby circuit 103, and a control circuit 110.

The switching circuit SW100 includes a first internal connection switching circuit SW101, a second internal connection switching circuit SW102, and a third internal connection switching circuit SW103. The first internal connection switching circuit SW101 is provided between an antenna port and a transmission port, the second internal connection switching circuit SW102 is provided between the antenna port and a reception port, and the third internal connection switching circuit SW103 is provided between the antenna port and a standby port.

The antenna 100 is connected to the antenna port. The transmission circuit 101 is connected to the transmission port. A high-frequency signal generated in the transmission circuit 101 is transmitted to the antenna 100 via the first internal connection switching circuit SW101 and sent out from the antenna 100.

The reception circuit 102 is connected to the reception port. A high-frequency signal received by the antenna 100 is transmitted to the reception circuit 102 via the second internal connection switching circuit SW102 and subjected to necessary processing such as amplification, demodulation, or the like in the reception circuit 102.

The standby circuit 103 is connected to the standby port. When this transmission/reception system is in a waiting state, the transmission circuit 101 and the reception circuit 102 are in a standby state where electric power is hardly consumed. When a high-frequency signal is inputted from the antenna 100 in this standby state, this high-frequency signal is received by the standby circuit 103 via the third internal connection switching circuit SW103 to start the operations of the other circuits, that is, the transmission circuit 101 and the reception circuit 102.

The first internal connection switching circuit SW101 includes a reactance element L101, capacitors C101 and C102, transistors Q101 and Q102, and resistances R101 and R102. In this embodiment, the transistors Q101 and Q102 are each constituted by a depletion mode MESFET.

More specifically, the capacitor C101 and the transistors Q101 and Q102 are connected in series between the antenna port and the transmission port. The reactance element L101 is connected in parallel with the capacitor C101 and the transistor Q101, and the capacitor C102 is connected in parallel with the transistor Q102. A gate of the transistor Q101 is connected to a control terminal T102 via the resistance R101, and a gate of the transistor Q102 is connected to the control terminal T102 via the resistance R102. These resistances R101 and R102 each have a relatively high resistance value (10 kΩ, for example). In this embodiment, a positive voltage or 0 V is inputted to the control terminal T102 from the control circuit 110. Incidentally, positive voltages in FIG. 6 are all the same voltage (5 V, for example). Here, 0 V applied from the control circuit 110 corresponds to a first voltage, and the positive voltage corresponds to a second voltage in this embodiment.

The second internal connection switching circuit SW102 includes a reactance element L102, capacitors C103 and C104, transistors Q103 and Q104, and resistances R103 and R104. In this embodiment, the transistors Q103 and Q104 are each constituted by a depletion mode MESFET.

The concrete connection relationship among these elements in the second internal connection switching circuit SW102 is the same as that in the aforementioned first internal connection switching circuit SW101. Also in this embodiment, the positive voltage or 0 V is inputted to a control terminal T103 from the control circuit 110.

The third internal connection switching circuit SW103 includes a transistor Q105 and a resistance R105. In this embodiment, the transistor Q105 is constituted by a depletion mode MESFET.

More specifically, the transistor Q105 is provided between the antenna port and the standby port. A gate of the transistor Q105 is connected to a ground via the resistance R105. Namely, a ground voltage is fixedly inputted to the gate of the transistor Q105. The resistance R105 has a relatively high resistance value (10 kΩ, for example).

The antenna port is connected to a control terminal T101 via a resistance R106. This resistance R106 has a sufficiently high resistance value (10 kΩ, for example) with respect to an impedance (50 Ω, for examle) of a high-frequency signal line. In this embodiment, the positive voltage or 0 V is also inputted to the control terminal T101 from the control circuit 110.

When the gate bias voltage of the control terminal T102 is 0 V, the transistors Q101 and Q102 are turned on, the first internal connection switching circuit SW101 becomes a parallel resonant circuit composed of the reactance element L101 and the capacitor C101, and thereby the high-frequency signal is cut off. Therefore, the transmission circuit 101 and the antenna port are separated from each other.

On the other hand, when the gate bias voltage of the control terminal T102 is a reverse bias, the transistors Q101 and Q102 are turned off, the first internal connection switching circuit SW101 becomes a series resonant circuit composed of the reactance element L101 and the capacitor C102, and thereby the high-frequency signal can pass therethrough. Therefore, the transmission circuit 101 and the antenna port are connected to each other.

Accordingly, values of the reactance elements L101 and L102 and the capacitors C101 to C104 are set to values such as resonate at a frequency to be used with consideration given to a stray capacitance such as the off capacitance of the FETs. The aforementioned cutoff/passage of the high-frequency signal applies to the second internal connection switching circuit SW102. Incidentally, in this embodiment, the reactance elements L101 and L102 are each formed by a coil.

Next, the concrete operation of the switching circuit SW100 will be explained. As shown in FIG. 6, when the transmission circuit 101 is connected to the antenna port, the control circuit 110 inputs the positive voltage to the control terminal T101 and the control terminal T103 and inputs 0 V to the control terminal T102. As a result, the gate bias voltages of the transistors Q101 and Q102 each become a reverse bias, and thereby the transistors Q101 and Q102 are turned off. Hence, as described above, the first internal connection switching circuit SW101 becomes the series resonant circuit composed of the reactance element L101 and the capacitor C102, whereby the high-frequency signal from the transmission circuit 101 is transmitted to the antenna port.

At this time, the gate bias voltages of the transistors Q103 and Q104 are 0 V, whereby the transistors Q103 and Q104 are turned on. Therefore, as described above, the second internal connection switching circuit SW102 becomes a parallel resonant circuit composed of the reactance element L102 and the capacitor C103, whereby the high-frequency signal from the antenna port is cut off. The gate bias voltage of the transistor Q105 also becomes a reverse bias, whereby the transistor Q105 is turned off. Hence, the standby circuit 103 is separated from the antenna port.

When the reception circuit 102 is connected to the antenna port, the control circuit 110 inputs the positive voltage to the control terminal T101 and the control terminal T102 and inputs 0 V to the control terminal T103. Consequently, in accordance with the same operation as described above, only the reception circuit 102 is connected to the antenna port.

When the standby circuit 103 is connected to the antenna port, the control circuit 110 inputs 0 V to the control terminals T101 to T103. As a result, the gate bias voltages of all the transistors Q101 to Q105 become 0 V, whereby all the transistors Q101 to Q105 are turned on. Accordingly, the first internal connection switching circuit SW101 becomes the parallel resonant circuit composed of the reactance element L101 and the capacitor C101, whereby the high-frequency signal is cut off. The second internal connection switching circuit SW102 becomes the parallel resonant circuit compose of the reactance element L102 and the capacitance C103, whereby the high-frequency signal is cut off. The third internal connection switching circuit SW103 is brought into a low-impedance state since the transistor Q105 is turned on, whereby the antenna port and the standby port are connected to each other.

As described above, in the switching circuit according to this embodiment, when all the control terminals T101 to T103 are set to 0 V, the antenna port is connected to the standby port, whereby, in a standby mode, power consumption can be reduced to a minimum. As a result, the available time of the system driven by the battery can be prolonged. Moreover, since the voltage applied to the control terminals T101 to T103 can be set to the positive voltage or 0 V, a negative control voltage is unnecessary, which makes it possible to simplify the entire configuration of this transmission/reception system.

### Second Embodiment

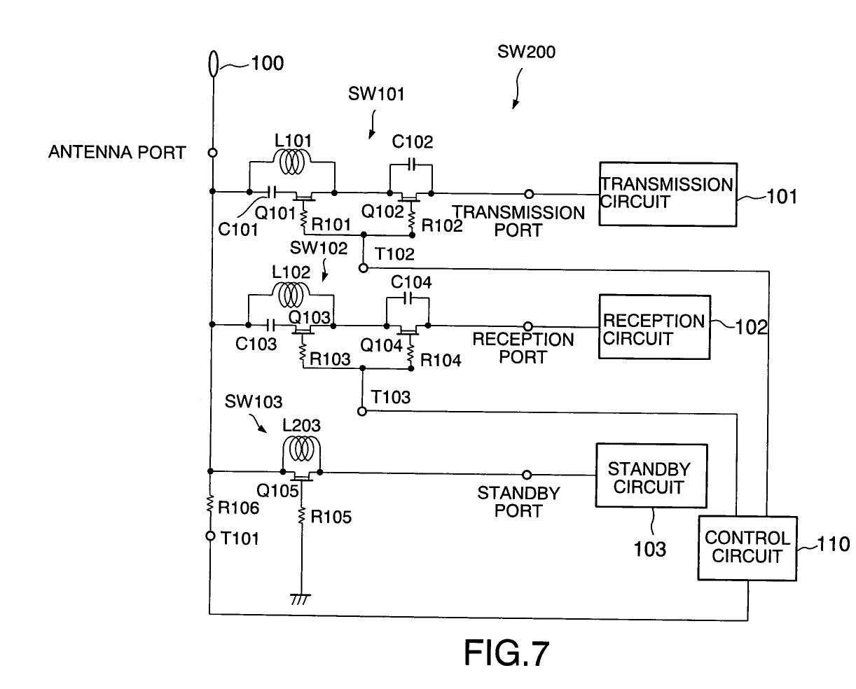

FIG. 7 is a diagram explaining the internal configuration of a transmission/reception system according to the second embodiment. This embodiment is different from the aforementioned first embodiment in the configuration of a switching circuit SW200.

As shown in FIG. 7, in the switching circuit SW200 according to this embodiment, a reactance element L203 is additionally connected in parallel with the transistor Q105 of the third internal connection switching circuit SW103. This reactance circuit L203 has an inductance which resonates with the off capacitance of the transistor Q105 at a frequency at which this switching circuit is used. Incidentally, in this embodiment, the reactance element L203 is formed by a coil.

Consequently, isolation between the antenna port and the standby port when the transistor Q105 is turned off can be improved as compared with the case where the reactance element L203 is not provided. Namely, a parallel resonant circuit is composed of the off capacitance of the transistor Q105 and the reactance element L203, whereby the high-frequency signal can be cut off more certainly.

Incidentally, the operation of the switching circuit in this embodiment is the same as that in the aforementioned first embodiment. Namely, a truth table to operate the switching circuit in FIG. 7 is the same as that in FIG. 6.

### Third Embodiment

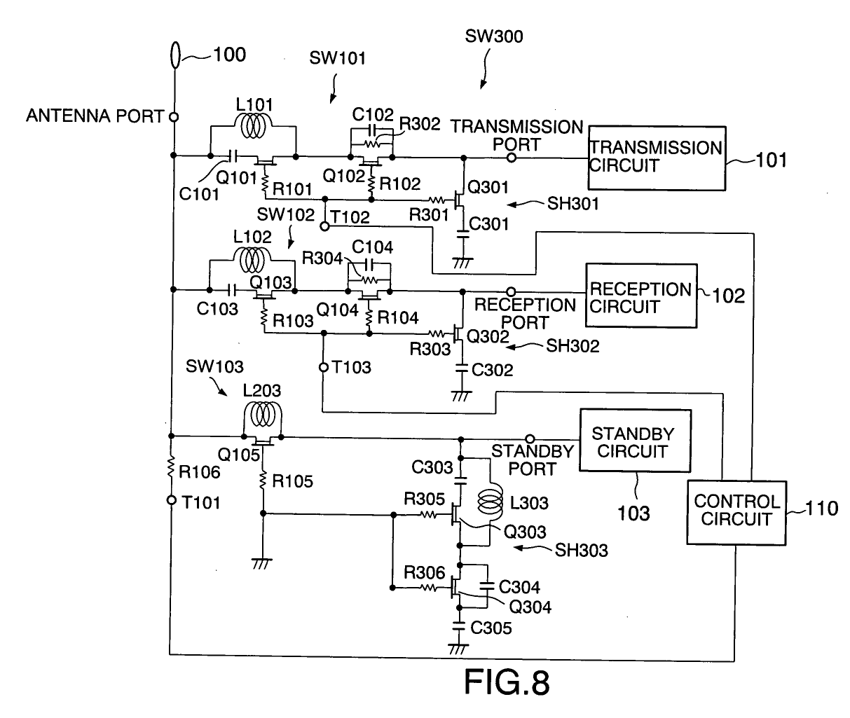

FIG. 8 is a diagram showing the configuration of a transmission/reception system according to this embodiment. As shown in FIG. 8, in a switching circuit SW300 of the transmission/reception system according to this embodiment, shunt circuits SH301, SH302, and SH303 are additionally connected to the transmission port, the reception port, and the standby port in the second embodiment, respectively. Namely, the shunt circuit SH301 is connected between the transmission port and the ground, the shunt circuit 302 is connected between the reception port and the ground, and the shunt circuit SH303 is connected between the standby port and the ground. Moreover, a resistance R302 is connected in parallel with the capacitor C102, and a resistance R304 is connected in parallel with the capacitor C104.

The shunt circuit SH301 includes a transistor Q301, a capacitor C301, and a resistance R301. In this embodiment, the transistor Q301 is constituted by a depletion mode MESFET. The transistor Q301 and the capacitor C301 are connected in series between the transmission port and the ground. A gate of the transistor Q301 is connected to the control terminal T102 via the resistance R301.

The shunt circuit SH302 includes a transistor Q302, a capacitor C302, and a resistance R303. In this embodiment, the transistor Q302 is constituted by a depletion mode MESFET. The transistor Q302 and the capacitor C302 are connected in series between the reception port and the ground. A gate of the transistor Q302 is connected to the control terminal T103 via the resistance R303.

The shunt circuit SH303 includes a reactance element L303, capacitors C303 to C305, transistors Q303 and Q304, and resistances R305 and R306. The capacitor C303, the transistor Q303, the transistor Q304, and the capacitor C305 are connected in series in this order between the standby port and the ground. The reactance element L303 is connected in parallel with the capacitor C303 and the transistor Q303. The capacitor C304 is connected in parallel with the transistor Q304. A gate of the transistor Q303 is connected to the ground via the resistance R305, and a gate of the transistor Q304 is connected to the ground via the resistance R306. In other words, in this embodiment, the ground voltage is fixedly inputted to the gates of the transistors Q303 and Q304. Incidentally, in this embodiment, the reactance element L303 is formed by a coil.

The operation of the switching circuit in this embodiment is the same as that in the aforementioned first embodiment. Namely, a truth table to operate the switching circuit SW300 in FIG. 8 is the same as that in FIG. 6.

When the transmission port is connected to the antenna port, the positive voltage is inputted to the control terminals T101 and T103, and 0 V is inputted to the control terminal T102. In this case, as explained in the first embodiment, the high-frequency signal from the transmission circuit 101 is transmitted to the antenna port, and the high-frequency signal from the antenna port to the reception circuit 102 and the standby circuit 103 is cut off.

Moreover, in this embodiment, the gate bias voltage of the transistor Q301 becomes a reverse bias, whereby the transistor Q301 is turned off. Namely, the positive voltage inputted to the control terminal T101 is applied to a drain of the transistor Q301 via the reactance element L101 and the resistance R302. Since the control terminal T102 is at 0 V, the gate bias voltage of the transistor Q301 becomes the reverse bias, whereby the transistor Q301 is turned off. When the transistor Q301 is turned off, the transmission port is separated from the ground, whereby the high-frequency signal outputted from the transmission circuit 101 is transmitted to the antenna port.

At this time, in the shunt circuit SH302, the positive voltage is inputted to the control terminals T101 and T103, whereby the gate bias voltage of the transistor Q302 becomes 0 V, and the transistor Q302 is turned on. Hence, the reception port is connected to the ground, whereby the high-frequency signal leaking from the antenna port is grounded.

In the shunt circuit SH303, the positive voltage of the control terminal T101 is applied to a source of the transistor Q303 and a drain of the transistor Q304 via the reactance elements L203 and L303. Consequently, the transistors 303 and Q304 are reverse-biased and turned off. Therefore, the shunt circuit SH303 becomes a series resonant circuit composed of the reactance element L303 and the capacitor C304, and the high-frequency signal can pass therethrough. Accordingly, the high-frequency signal leaking from the antenna port is grounded.

When the reception port is connected to the antenna port, the positive voltage is inputted to the control terminals T101 and T102, and 0 V is inputted to the control terminal T103. In this case, as explained in the first embodiment, the reception circuit 102 is connected to the antenna port, and the transmission circuit 101 and the standby circuit 103 are separated from the antenna port. Further, in this embodiment, in accordance with the same operation as described above, the shunt circuit SH301 is turned on, whereby the high-frequency signal leaking from the antenna port is grounded, and the shunt circuit SH303 is also turned on, whereby the high-frequency signal leaking from the antenna port is grounded. The shunt circuit SH302 is turned off, whereby the high-frequency signal from the antenna port is transmitted to the reception circuit 102.

When the standby port is connected to the antenna port, 0 V is inputted to all of the control terminals T101, T102, and T103. In this case, as explained in the first embodiment, the standby circuit 103 is connected to the antenna port, and the transmission circuit 101 and the reception circuit 102 are separated from the antenna port. Moreover, in this embodiment, in accordance with the same operation as described above, the shunt circuit SH301 is turned on, whereby the high-frequency signal leaking from the antenna port is grounded, and the shunt circuit SH302 is also turned on, whereby the high-frequency signal leaking from the antenna port is grounded.

In the shunt circuit SH303, the gate bias voltages of the transistors Q303 and Q304 become 0 V, whereby the transistors Q303 and Q304 are turned on, and hence the shunt circuit SH303 becomes a parallel resonant circuit composed of the capacitor C303 and the reactance element L303. Consequently, in the shunt circuit SH303, the high-frequency signal from the antenna port is cut off and transmitted to the standby circuit 103.

As described above, according to the switching circuit of this embodiment, the transmission port, the reception port, and the standby port are provided with the shunt circuits SH301 to SH303, respectively, and all but the ports connected to the antenna port are connected to the ground, whereby the leaking high-frequency signal can be grounded.

It should be mentioned that the present invention is not limited to the aforementioned embodiments, and various changes may be made therein. For example, in the aforementioned embodiments, each of the transistors is formed by the MESFET which is constituted by using a compound semiconductor, but it may be formed by a HEMT (High Electron Mobility Transistor) which is constituted by using the compound semiconductor or a J-FET (Junction FET).

Furthermore, in the aforementioned embodiments, the switching circuits SW100, SW200, and SW300 are each implemented on one semiconductor chip, but the switching circuit, including the transmission circuit 101, the reception circuit 102, the standby circuit 103, and the control circuit 110, may be implemented on one semiconductor chip.

1. A switching circuit, comprising:
a transmission port which is connectable to a transmission circuit;
a first internal connection switching circuit which is connected between the transmission port and an antenna port and which includes a depletion mode first transistor and a depletion mode second transistor, the first internal connection switching circuit constituting a parallel resonant circuit by turning on the first transistor and the second transistor, and constituting a series resonant circuit by turning off the first transistor and the second transistor;
a reception port which is connectable to a reception circuit;
a second internal connection switching circuit which is connected between the reception port and the antenna port and which includes a depletion mode third transistor and a depletion mode fourth transistor, the second internal connection switching circuit constituting a parallel resonant circuit by turning on the third transistor and the fourth transistor, and constituting a series resonant circuit by turning off the third transistor and the fourth transistor;
a standby port which is connectable to a standby circuit;
a third internal connection switching circuit which is connected between the standby port and the antenna port and which includes a depletion mode fifth transistor, the third internal connection switching circuit connecting the standby port to the antenna port by turning on the fifth transistor, and separating the standby port from the antenna port by turning off the fifth transistor; and
a control terminal which is connected to the antenna port and to which a first voltage is inputted when the standby port is connected to the antenna port such that gate bias voltages of the first to fifth transistors become 0 V and the first to fifth transistors are turned on.

2. The switching circuit according to claim 1, wherein when the standby port is connected to the antenna port, the first voltage is also inputted to gates of the first to fourth transistors.

3. The switching circuit according to claim 2, wherein when the transmission port is connected to the antenna port, the first voltage is inputted to the gates of the first transistor and the second transistor and a second voltage is inputted to the gates of the third transistor and the fourth transistor and the control terminal.

4. The switching circuit according to claim 3, wherein when the reception port is connected to the antenna port, the first voltage is inputted to the gates of the third transistor and the fourth transistor and the second voltage is inputted to the gates of the first transistor and the second transistor and the control terminal.

5. The switching circuit according to claim 4, wherein the first voltage is fixedly inputted to a gate of the fifth transistor.

6. The switching circuit according to claim 1, wherein the first internal connection switching circuit comprises:
a first reactance element and a first capacitor which are connected in series between the antenna port and the transmission port; and
a second capacitor which is connected in parallel with the first reactance element,
the first transistor is connected in parallel with the first reactance element and in series with the second capacitor, and
the second transistor is connected in parallel with the first capacitor.

7. The switching circuit according to claim 6, wherein the second internal connection switching circuit comprises:
a second reactance element and a third capacitor which are connected in series between the antenna port and the reception port; and
a fourth capacitor which is connected in parallel with the second reactance element,
the third transistor is connected in parallel with the second reactance element and in series with the fourth capacitor, and
the fourth transistor is connected in parallel with the third capacitor.

8. The switching circuit according to claim 1, wherein the third internal connection switching circuit comprises a third reactance element which is connected in parallel with the fifth transistor.

9. The switching circuit according to claim 1, further comprising:
a first shunt circuit which connects the transmission port to a ground when the transmission port is not connected to the antenna port and which separates the transmission port from the ground when the transmission port is connected to the antenna port;
a second shunt circuit which connects the reception port to the ground when the reception port is not connected to the antenna port and which separates the reception port from the ground when the reception port is connected to the antenna port; and
a third shunt circuit which connects the standby port to the ground when the standby port is not connected to the antenna port and which separates the standby port from the ground when the standby port is connected to the antenna port.

10. The switching circuit according to claim 9, wherein the first shunt circuit comprises a sixth transistor and a fifth capacitor which are connected in series between the transmission port and the first voltage, and
when the transmission port is connected to the antenna port, the sixth transistor is turned off, and when the transmission port is not connected to the antenna port, the sixth transistor is turned on.

11. The switching circuit according to claim 10, wherein the second shunt circuit comprises a seventh transistor and a sixth capacitor which are connected in series between the reception port and the first voltage, and
when the reception port is connected to the antenna port, the seventh transistor is turned off, and when the reception port is not connected to the antenna port, the seventh transistor is turned on.

12. The switching circuit according to claim 11, wherein the third shunt circuit comprises:
a seventh capacitor, an eighth transistor, and a ninth transistor which are connected in series between the standby port and the first voltage;
a fourth reactance element which is connected in parallel with the seventh capacitor and the eighth transistor; and
an eighth capacitor which is connected in parallel with the ninth transistor,
when the standby port is connected to the antenna port, the eighth transistor and the ninth transistor are turned on and the seventh capacitor and the fourth reactance element constitute a parallel resonant circuit, and when the standby port is not connected to the antenna port, the eighth transistor and the ninth transistor are turned off and the fourth reactance element and the eighth capacitor constitute a series resonant circuit.

13. The switching circuit according to claim 12, wherein the first internal connection switching circuit further comprises a first resistance which is connected in parallel with the first capacitor.

14. The switching circuit according to claim 13, wherein the second internal connection switching circuit further comprises a second resistance which is connected in parallel with the third capacitor.

15. The switching circuit according to claim 1, wherein each of the first to fifth transistors is an FET in which if a gate bias voltage is a reverse bias, a reverse current flows from a gate to a source or a drain.

16. The switching circuit according to claim 15, wherein the first to fifth transistors are each constituted by using a compound semiconductor.

17. The switching circuit according to claim 16, wherein the first voltage is 0 V and the second voltage is a positive voltage.
